(19) United States
(12) Patent Application Publication
(10) Pub. No.: US 2015/0243048 A1
(43) Pub. Date: Aug. 27, 2015

(54) SYSTEM, METHOD, AND COMPUTER PROGRAM PRODUCT FOR PERFORMING ONE-DIMESIONAL SEARCHES IN TWO-DIMENSIONAL IMAGES

(71) Applicant: NVIDIA Corporation, Santa Clara, CA (US)

(72) Inventors: Kihwan Kim, Sunnyvale, CA (US); Dawid Stanislaw Pajak, San Jose, CA (US); Kari Antero Pulli, Palo Alto, CA (US)

(73) Assignee: NVIDIA Corporation, Santa Clara, CA (US)

(21) Appl. No.: 14/191,332

(22) Filed: Feb. 26, 2014

(51) Int. Cl. G06T 7/40; G06K 9/46; G06T 7/00

(52) U.S. Cl. CPC G06T 7/408; G06T 7/0081; G06K 9/4642; G06K 9/4609; G06K 9/4652; G06T 2207/10004; G06T 2207/10024

(57) ABSTRACT

A system, method, and computer program product are provided for implementing a search of a digital image along a set of paths. The method includes the steps of selecting a set of paths in an image and identifying at least one feature pixel in the set of paths by comparing gradients for each of the pixels in the set of paths. The set of paths includes at least one line of pixels in the image, and a total number of pixels in the set of paths is less than half of a number of pixels in the image.

### FIELD OF THE INVENTION

The present invention relates to image processing, and more particularly to techniques related to feature recognition.

### BACKGROUND

Feature matching techniques are essential for many conventional computer vision applications such as image registration, sparse feature tracking, and local template matching for object detection. Generally, the conventional feature matching techniques detect local points (e.g., corners, or center of a surface with maximum curvature) to determine candidates for matching points in one image to points in another image. While such descriptor-based matching schemes have been proven to be robust when dealing with large displacements and/or rotation and scale transformations, these techniques may be overly complicated for scenes having only moderate transformations. Furthermore, such techniques may not be suitable for applications on mobile devices or in applications that require interactive frame rates due to excessive computational loads. Thus, there is a need for addressing these issues and/or other issues associated with the prior art.

### SUMMARY

A system, method, and computer program product are provided for implementing a search of a digital image along a set of paths. The method includes the steps of selecting a set of paths in an image and identifying at least one feature pixel in the set of paths by comparing gradients for each of the pixels in the set of paths. The set of paths includes at least one line of pixels in the image, and a total number of pixels in the set of paths is less than half of a number of pixels in the image.

### BRIEF DESCRIPTION OF THE DRAWINGS

FIG. 1 illustrates a flow chart of a method for implementing a search of a digital image along a set of paths, in accordance with one embodiment;

FIG. 2 illustrates a device configured to perform a feature search of a digital image, in accordance with one embodiment;

FIG. 3 illustrates the image processing pipeline of FIG. 2, in accordance with one embodiment;

FIG. 4A illustrates a block of pixels that includes one or more features, in accordance with one embodiment;

FIG. 4B illustrates a technique for performing a search for features of a digital image, in accordance with one embodiment;

FIG. 4C illustrates a technique that utilizes the search for features of the digital image, in accordance with one embodiment;

FIGS. 5A through 5I illustrate a technique for implementing a feature search algorithm of a digital image, in accordance with another embodiment;

FIGS. 6A & 6B illustrate one application of the feature recognition algorithm, in accordance with one embodiment;

FIG. 7A illustrates a flow chart of a method for performing a search of a digital image, in accordance with another embodiment;

FIG. 7B illustrates a flow chart of a method for performing a search of a digital image, in accordance with yet another embodiment; and

FIG. 8 illustrates an exemplary system in which the various architecture and/or functionality of the various previous embodiments may be implemented.

### DETAILED DESCRIPTION

The disclosed system and technique may be implemented on embedded systems or mobile devices that have limited computational resources. However, even with limited computational resources, the algorithms implemented by such computer vision applications may still require high-quality results that are computationally demanding. Furthermore, some applications may be required to operate in real-time using interactive frame rates.

One way to reduce the computational load of prior art techniques is to perform the search on a smaller segment of the image while attempting to maintain high-quality results. Many algorithms search the images for features to detect pixels of particular interest to the application. For example, an image may be searched to detect edges such that edges in one image may be matched to corresponding edges in another image. Such features typically cross many rows or columns of pixels (i.e., features tend to have a dimension that is larger than one or two pixels). Consequently, the computational load of the algorithms may be reduced by searching for features in an image using a small subset of pixels in the whole image. For example, features may be discovered in a robust manner by searching every 3^{rd} row of pixels to look for boundaries or edges that intersect those rows. This technique may lead to a reduction in the computational workload of the algorithm by ⅓. Further reductions may be made by searching through even fewer pixels. As long as the features are large compared to the size of the pixels, or if the algorithm is still robust even when only a fraction of all features in the image are discovered, then the computational workload of such algorithms may be significantly reduced (e.g., the algorithms may be 10-100× faster than comparable prior art techniques).

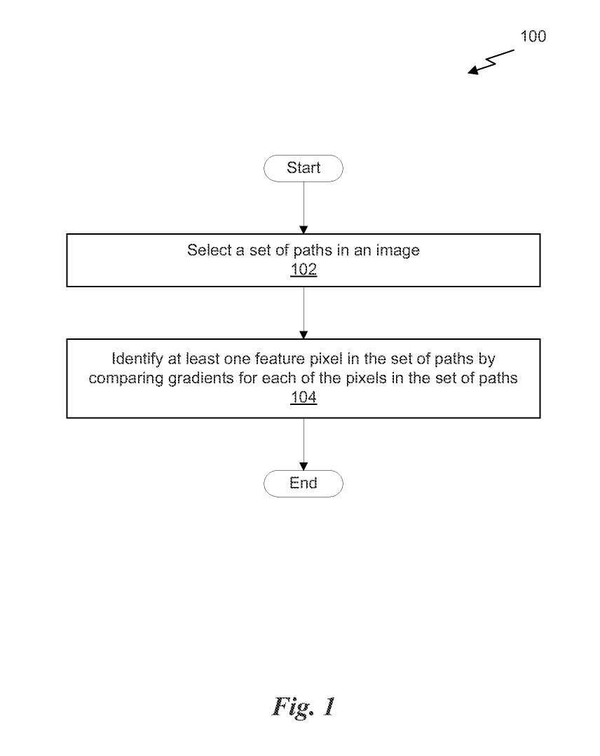

FIG. 1 illustrates a flow chart of a method 100 for implementing a search of a digital image along a set of paths, in accordance with one embodiment. At step 102, a set of paths in an image is selected. In the context of the following description, a set of paths in an image comprises a subset of pixels in the image that form one or more paths. In one embodiment, the set of paths may include a line of pixels. The line of pixels may be horizontal, vertical, or at any other orientation (i.e., at various angles relative to the horizontal and vertical axes). In one embodiment, the line of pixels may be n pixels long and one or more pixels wide. The line of pixels may extend across the entire extents of the image or may be limited to only a portion of the image. In one embodiment, the portion of the image may be, e.g., a block of pixels that is N pixels by M pixels.

In another embodiment, the set of paths may include multiple lines of pixels. For example, the set of paths may include every n^{th} row of pixels in the image and/or every n^{th} column of pixels in the image. In yet another embodiment, the image may be divided into a plurality of blocks and the set of paths may include one or more lines of pixels selected in each block. The set of paths may include a subset of pixels in the image that is less than half of the total number of pixels in the image. For example, the set of paths may be selected as every fourth line of pixels in the image (i.e., 25% of the total pixels in the image) or selected as every tenth line of pixels in the image (i.e., 10% of the total pixels in the image). The smaller the ratio of the number of pixels in the set of paths to the total number of pixels in the image, the more the computational load of the algorithm may be reduced. It will be appreciated that the set of paths is not limited to a set of straight lines, and that any path, curved or straight, may be included in the set of paths.

At step 104, at least one feature pixel in the set of paths is identified by comparing gradients for each of the pixels in the set of paths. A gradient value for a pixel is calculated by comparing a value for one or more components of that pixel with one or more corresponding components of an adjacent pixel. For example, a gradient value associated with a red component for a pixel may be calculated by taking the difference between the red component for that pixel and the red component for an adjacent pixel. Gradient values may also be calculated in any other manner well known in the art. In one embodiment, a feature pixel is identified if at least one gradient value identified with a pixel is above a threshold value. In another embodiment, a feature pixel is identified when the gradient value is a local maximum for all gradient values in the set of paths within a certain distance from that pixel. For example, if no pixels within 15 pixels along the set of paths is associated with a gradient larger than that particular pixel, then that pixel is identified as a feature pixel. In yet another embodiment, a second derivative of pixel intensities may be calculated (i.e., gradients of pixel gradients), and any pixel associated with a local minimum of the second derivatives of pixel intensities may be identified as a feature pixel.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

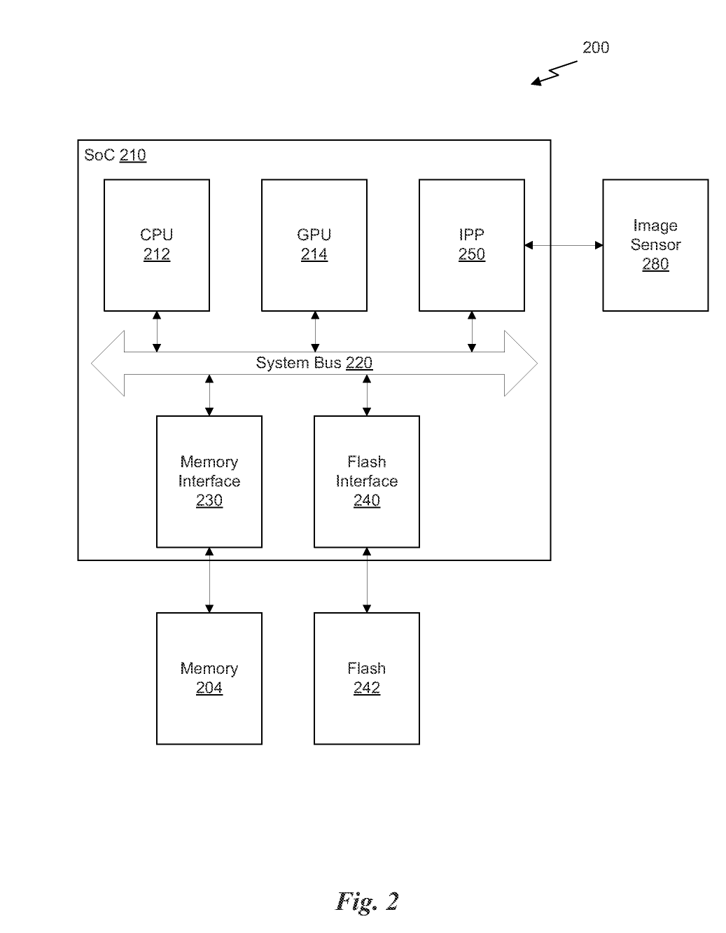

FIG. 2 illustrates a device 200 configured to perform a feature search of a digital image, in accordance with one embodiment. The device 200 may be, e.g., a desktop computer, a laptop computer, a tablet computer, a digital camera, a smart phone, a personal digital assistant (PDA), or the like. As shown in FIG. 2, the device 200 includes a system-on-chip (SoC) 210, a memory 204, a flash memory 242, and an image sensor 280. The memory 204 comprises one or more memory modules for temporary storage of volatile data. In one embodiment, the memory 204 comprises one or more dynamic random access memory (DRAM) modules. The flash memory 242 comprises a flash memory device that provides non-volatile, long term storage of data. In some embodiments, the flash memory 242 may be replaced by other types of non-volatile memory such as read-only memory (ROM), solid state drives (SSDs), optical disks (e.g., CD-ROM, DVD-ROM, etc.), secure digital (SD) cards, and the like. It will be appreciated that data, as used herein, refers to both program instructions and raw data processed by the instructions.

In one embodiment, the SoC 210 includes a central processing unit (CPU) 212, a graphics processing unit (GPU) 214, a memory interface 230, a flash interface 240, an image processing pipeline 250, and a system bus 220. Each of the components of the SoC 210 may communicate with one or more of the other components via the system bus 220. The SoC 210 is implemented on a single silicon substrate and may be included in an integrated circuit package that provides an interface to a printed circuit board (PCB) that includes external interconnects to the other components of the device 200. In one embodiment, the CPU 212 is a reduced instruction set computer (RISC) such as an ARM® Cortex A9, 32-bit multi-core processor. The CPU 212 may have one or more cores and may be multi-threaded to execute two or more instruction per clock cycle in parallel. In other embodiments, the CPU 212 may be a MIPS based microprocessor or other type of RISC processor.

The CPU 212 retrieves data from the memory 204 via the memory interface 230. In one embodiment, the memory interface 230 includes a cache for temporary storage of data from the memory 204. The memory interface 230 implements a 32-bit DDR (double data rate) DRAM interface that connects to the memory 204. The CPU 212 may also retrieve data from the flash memory 242 to be written into the memory 204 via the flash interface 240 that, in one embodiment, implements an Open NAND Flash Interface (ONFI) specification, version 3.1. It will be appreciated that the flash interface 240 may be replaced by other types of interfaces for flash memory or other non-volatile memory devices, as required to interface with the particular type of non-volatile memory included in the device 200. For example, the flash interface 240 could be replaced by an IDE (Integrated Drive Electronics) interface (i.e., Parallel ATA) for connection to a solid state drive (SSD) in lieu of the flash memory 242.

In one embodiment, the SoC 210 includes a GPU 214 for processing graphics data for display on a display device, such as a liquid crystal display (LCD) device, not explicitly shown in FIG. 2. The GPU 214 implemented in the SoC 210 may be a low-power version of a discrete GPU. The GPU 214 includes a plurality of streaming processors configured to efficiently process highly parallel tasks, such as pixel processing. The GPU 214 may be configured to write processed pixel data to a frame buffer in the memory 204. A video interface, not explicitly shown in FIG. 2, may then be configured to read the pixel data from the frame buffer and generate video signals to transmit to the display device included in device 200 or connected to device 200 via an interface such as an HDMI (High-Definition Multimedia Interface) connector.

In some embodiments, the device 200 also includes an image sensor 280 for capturing digital images. The SoC 210 may transmit signals to the image sensor 280 that cause the image sensor 280 to sample pixel sites on the image sensor 280 that indicate a level of a particular wavelength or wavelengths of light focused on the pixel site. The level may be expressed as a level of luminosity for either a red, a green, or a blue channel that is transmitted to the SoC 210 as raw image sensor data. In one embodiment, the image sensor 280 is a CMOS (Complementary Metal Oxide Semiconductor) image sensor. In another embodiment, the image sensor 280 is a CCD (Charge Coupled Device) image sensor. It will be appreciated that the image sensor 280 may be included in an image sensor assembly that includes, in addition to the image sensor 280, one or more of a lens, a shutter mechanism, a filter or color filter array, and the like. Some image sensor assemblies may include more than one lens, or the ability for a user to attach various lenses to the image sensor assembly that focus light on the surface of the image sensor 280.

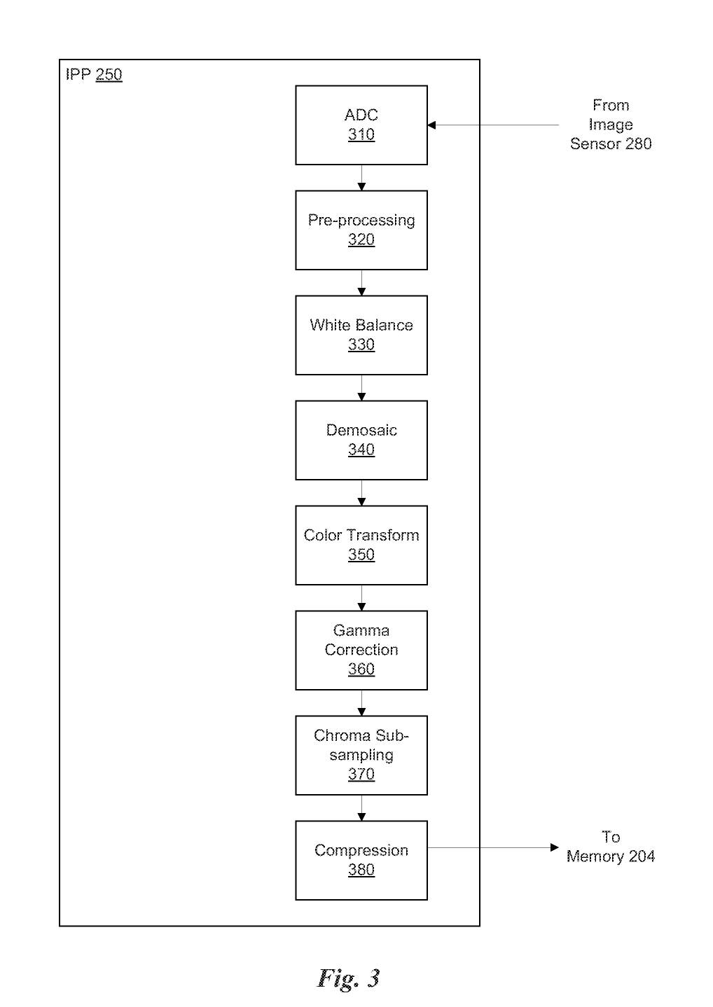

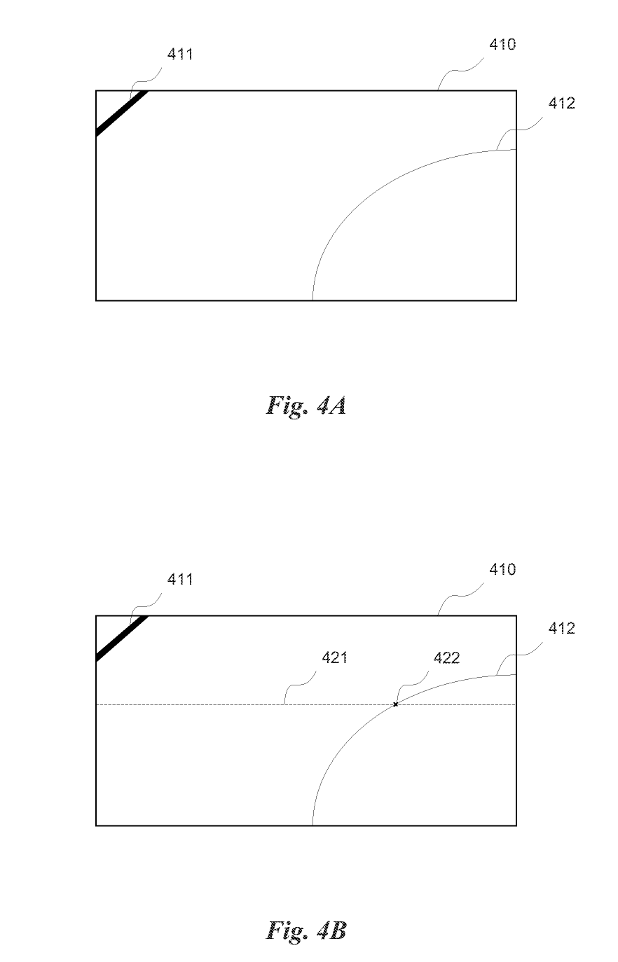

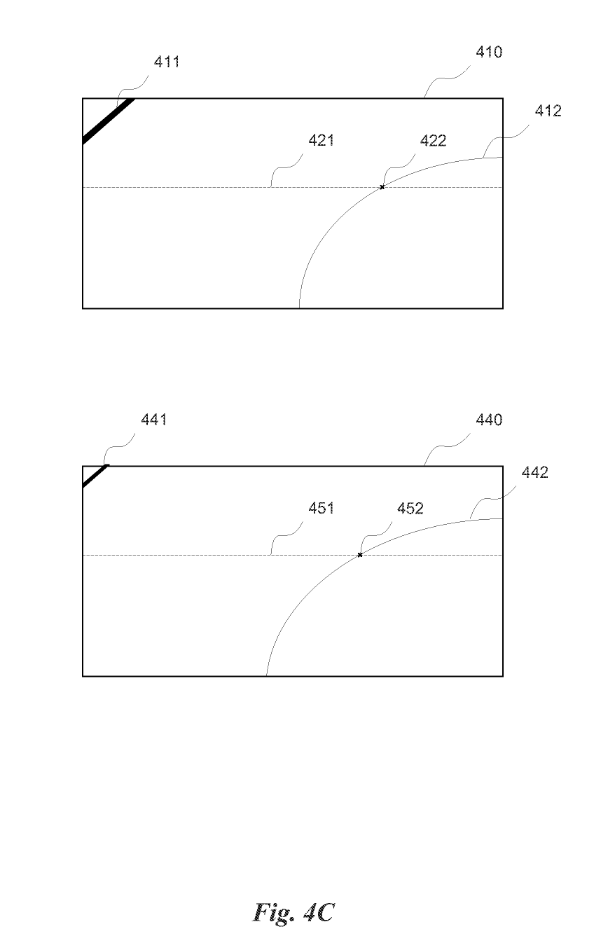

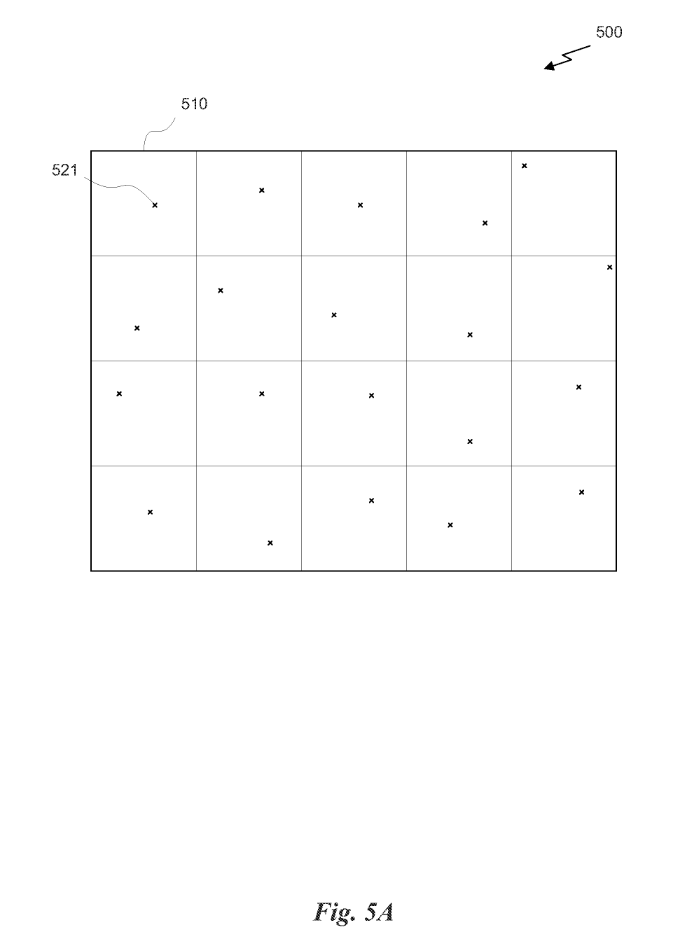

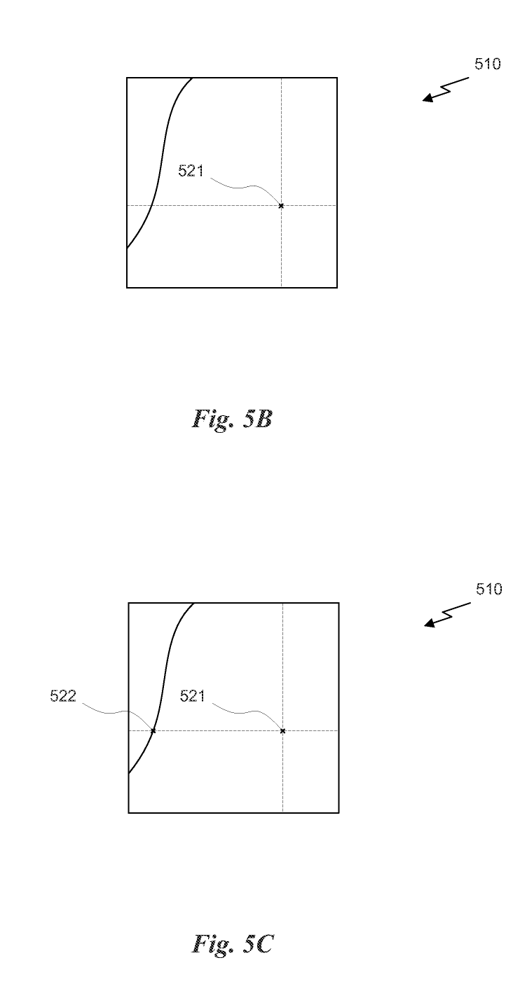

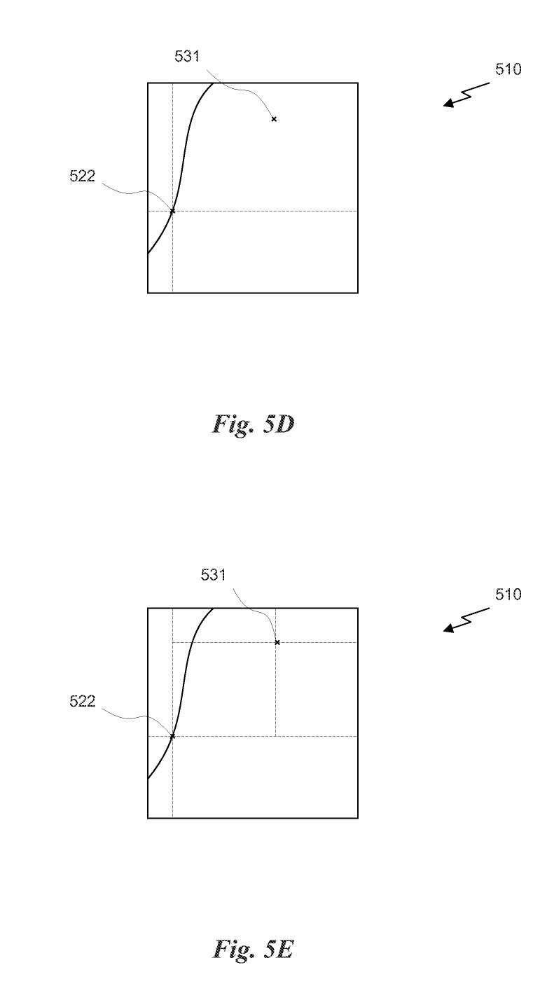

In one embodiment, raw image sensor data may be transmitted to the image processing pipeline (IPP) 250 for processing. The SoC 210 may include IPP 250 as a discrete hardware unit within the single silicon substrate. In another embodiment, the SoC 210 may implement the functions of the IPP 250 via instructions executed by the CPU 212, the GPU 214, or a combination of the CPU 212 and the GPU 214. The IPP 250 will be described in more detail below in conjunction with FIG. 3.

FIG. 3 illustrates the image processing pipeline 250 of FIG. 2, in accordance with one embodiment. As shown in FIG. 3, the IPP 250 includes an analog-to-digital converter (ADC) 310, a pre-processing engine 320, a white balance engine 330, a demosaicing engine 340, a color transformation engine 350, a gamma correction engine 360, a chroma subsampling engine 370, and a compression engine 380. It will be appreciated that the IPP 250 is shown for illustration purposes and that the particular stages of the IPP 250 implemented by various manufacturers may be different. In other words, the IPP 250 may include additional stages in addition to or in lieu of the stages shown in FIG. 3.

In one embodiment, the ADC 310 receives the raw image sensor data and, for each pixel site, converts an analog signal into a digital value (i.e., an intensity value). In one embodiment, the ADC 310 has a resolution of eight or more bits and converts the analog signal for each pixel site into an 8-bit intensity value between 0 and 350. In another embodiment, the ADC 310 is built into the image sensor assembly and digital values are transmitted to the IPP 250 via a serial interface.

In one embodiment, the pre-processing engine 320 implements various processing algorithms based on the raw image sensor data. In one embodiment, the pre-processing engine 320 implements a filter to reduce cross-talk between pixel sites. In another embodiment, the pre-processing engine 320 implements a noise reduction algorithm. In yet other embodiments, the pre-processing engine 320 implements an image cropping algorithm. In still yet other embodiments, the pre-processing engine 320 implements an image scaling algorithm. It will be appreciated that various manufacturers of the device 200 may implement one or more processing algorithms within the functionality of the pre-processing engine 320.

The white balance engine 330 is configured to adjust the intensity values for each color channel in the processed image data to account for a color temperature of a light source. For example, fluorescent lighting and natural sunlight cause the same colored object to appear different in a digital image. The white balance engine 330 can adjust the intensity values for each pixel to account for differences in the light source.

The demosaicing engine 340 blends intensity values from different pixel sites of the image sensor 280 to generate pixel values associated with multiple color channels in a digital image. Most conventional image sensors include a color filter array such that each pixel site of the image sensor is associated with a single color channel. For example, a Bayer Filter Mosaic color filter includes two green filters, one red filter, and one blue filter for every 2×2 array of pixel sites on the image sensor. Each pixel site of the raw image sensor data is associated with only one color (e.g., red, green, or blue). The demosaicing engine 340 applies a special kernel filter to sample a plurality of pixel sites in the raw image sensor data to generate each composite pixel in the digital image, where each composite pixel is associated with three or more color channels (e.g., RGB, CMYK, etc.). The demosaicing engine 340 decreases the spatial resolution of the digital image in order to generate pixels of blended colors.

The color transformation engine 350 transforms the digital image generated by the demosaicing engine 340 from a non-linear, device dependent color space to a linear, device-independent color space. For example, the RGB color space is a non-linear, device dependent color space. The function of the color transformation engine 350 is to map the intensity of colors in the non-linear, device-dependent color space associated with the image sensor 280 to a standard, linear color space such as sRGB. The color transformation engine 350 transforms each pixel value (i.e., a vector of multiple color channels) by application of a 3×3 color transformation matrix to generate a transformed pixel value.

The gamma correction engine 360 adjusts the intensity values of the pixels of the digital image such that the digital image, when displayed on a display device with a non-linear response, properly reproduces the true colors of the captured scene. The chroma subsampling engine 370 divides the three chrominance channels (e.g., red, green, and blue) of the transformed pixels into a single luminance channel and two color difference channels. Because human vision responds more to luminance differences than chrominance differences, the two color difference channels can be stored using less bandwidth than the luminance channel without reducing the overall quality of the digital image. The compression engine 380 receives the uncompressed digital image from the chroma subsampling engine 370 and generates a compressed digital image for storage in a memory 204. In one embodiment, the compression engine 380 compresses the image using a JPEG (Joint Pictures Expert Group) codec to generate a JPEG encoded digital image file.

It will be appreciated that the number and order of the various components of the IPP 250, set forth above, may be different in various embodiments implemented by different manufacturers of the device 200. For example, in some embodiments, digital images may be stored in a RAW image format and the demosaicing engine 340 is not included in the IPP 250. In other embodiments, the chroma subsampling engine 370 and the compression engine 380 are not included in the IPP 250 because the digital image is stored in an uncompressed bitmap that describes pixels in the sRGB color space. It will be appreciated that different applications require different combinations and order of engines configured to implement various algorithms and that other processing engines, not described herein, may be added to or included in the IPP 250 in lieu of the processing engines described above.

FIG. 4A illustrates a digital image 410 that includes one or more features, in accordance with one embodiment. The digital image 410 comprises a two-dimensional array of pixels, where each pixel is specified by an x-coordinate (i.e., indicating a horizontal index for the pixel) and a y-coordinate (i.e., indicating a vertical index for the pixel). Each pixel may include multiple intensity values for different color components (i.e., channels). The digital image 410 may include one or more features. The features may be points, edges, corners, and the like. In one embodiment, a feature is defined by any boundary between two pixels associated with a gradient above a particular threshold. A gradient is defined as the difference between an intensity value of one pixel and a corresponding intensity value of a neighboring pixel. Gradients for a pixel may be defined for the x and y directions, or along any other orientation, and may be defined for each channel of the associated pixels or as a combination of two or more channels of the associated pixels (i.e., the gradient may be an average gradient for multiple channels of the pixels). For example, Grₓ may define the gradient for the red color channel of a pixel along the x-axis, Gr_{y} may define the gradient for the red color channel of the pixel along the y-axis, Gr_{xy} may define the gradient for the red color channel of the pixel along a diagonal, and Gr_{yx} may define the gradient for the red color channel of the pixel along the other diagonal. As shown in FIG. 4A, the digital image 410 includes a line feature 411 in the upper left corner of the image and a curve feature 412 in the lower right corner of the image.

Conventional feature recognition algorithms may be configured to process each pixel in the digital image 410 to calculate gradients for each pixel in one or more directions. It will be appreciated that such conventional approaches may be very computationally intensive. For example, if the digital image 410 includes 256 pixels in the x-direction and 128 pixels in the y-direction, then two gradients per channel may be calculated for over 32 thousand pixels. It will be appreciated that most images used in feature recognition algorithms may be much larger than 256×128 pixels and, therefore, a much larger number of calculations may be performed when processing every pixel in the digital image.

FIG. 4B illustrates a technique for performing a search for features of a digital image 410, in accordance with one embodiment. The search may be utilized to find features in the digital image in a less computationally intensive manner than compared to conventional techniques. Features (i.e., edges) found in digital images tend to be larger than one pixel. In practice, many edges in an image will span tens or even hundreds of lines of pixels depending on the subject matter of the image. Therefore, by limiting the search methodology to analyze only a subset of the pixels in an image, many features are likely to still be detected even though the number of computations performed by the search algorithm is greatly reduced.

As shown in FIG. 4B, a line of pixels 421 may be selected in the digital image 410. The line of pixels 421 may be selected randomly. For example, a random number generator may be used to select a particular line of pixels in the digital image 410. In another embodiment, the line of pixels 421 may be pre-selected at a particular location in the digital image 410. For example, a line of pixels that bisects the digital image 410 may be selected. Then, each pixel in the line of pixels 421 is analyzed to identify one or more edges that intersect the line of pixels 421. In one embodiment, a processor, such as CPU 212 or GPU 214, is configured to calculate at least one gradient for each pixel in the line of pixels 421. For example, for the line of pixels 421, the processor calculates a gradient in the x direction for each pixel by comparing an intensity of the pixel, in at least one channel, with a corresponding intensity of one or more adjacent pixels. Once every gradient has been calculated, the gradients are analyzed to determine which pixels in the line of pixels 421 are associated with gradients above a threshold value. Each pixel in the line of pixels 421 that has a gradient above the threshold value is identified as a potential feature pixel. As shown in the digital image 410, a feature pixel 422 in the line of pixels 421 is associated with the feature 412. These feature pixels are likely be associated with features or edges in the digital image 410. Also, based on the selection of the line of pixels 421, it is apparent that the line of pixels 421 does not intersect with the feature 411.

Again, feature pixels may be identified based on other techniques for analyzing the gradient values. For example, a plurality of gradient values for pixels within a specific distance of a source pixel may be analyzed to find a local maximum of the gradient values. In another example, gradients of the gradient values may be calculated to find second derivatives of the pixel intensities and a local minimum of the second derivative values may be identified. Other technically-feasible techniques for identifying feature pixels based on gradient values associated with the line of pixels are contemplated as being within the scope of the present disclosure.

As shown, the search of the digital image 410 involves far fewer computations than conventional approaches that calculate gradients for each pixel in the digital image 410. Even so, the search of the digital image 410 yields results that identify at least some of the features in the digital image 410. Results may be improved by repeating the search for multiple lines of pixels in the digital image 410. For example, every n^{th} line of pixels in the digital image may be searched to detect feature pixels in the digital image 410. It will be appreciated that even though the line of pixels 421 does not intersect the feature 411, a different line of pixels may intersect the feature 411, and that by selecting and searching multiple lines of pixels, a probability that more features in the digital image 410 will be detected is increased. In some embodiments, the set of paths may be selected to include both horizontal lines of pixels and vertical lines of pixels to form a grid. Such grids will be more apt to intersect features that span many lines of pixels in either the horizontal direction or the vertical direction, when such features might not have intersected a set of paths that only included horizontal lines of pixels or vertical lines of pixels.

FIG. 4C illustrates a technique that utilizes the detected features of the digital image 410, in accordance with one embodiment Detecting features in images is useful for various algorithms in computer imaging. For example, feature detection can be used to track objects in one image with objects in another related image. Feature detection is also useful in high dynamic range (HDR) imaging where image stacks must be registered and combined in order to produce an HDR image. The technique illustrated in FIG. 4C is merely one example for utilizing the feature detection algorithm described above, and the feature detection algorithm may be applied to other techniques.

Once a feature pixel 422 is detected in a first digital image 410, a second digital image 440 may be searched to find a matching pixel 452 in the second digital image 440. As shown in FIG. 4C, the second digital image 440 may also include features(e.g., 441 and 442) that substantially match the features in the first digital image 410, but those features may have moved with respect to the camera or with respect to the other features. The motion of the objects may be caused either by camera motion (e.g., camera motion caused by jitter of a hand-held device) or motion of the objects themselves relative to other objects in the scene. It will be appreciated that, in some instances, objects may be occluded in one image but not the other image such that some features appear in one image but not the other image. In one embodiment, the feature detection algorithm may be implemented as part of an image registration algorithm that attempts to determine how the second image 440 is related to the first image 410 by way of a transformation (e.g., translation, rotation, or other affine transformations). In order to register the images, feature pixels in one image are matched to corresponding feature pixels in another image.

To select a pixel in the second digital image 440 that matches the feature pixel 422, a corresponding line of pixels 451 in the second digital image 440 is selected. In one embodiment, the corresponding line of pixels 451 is located at the same location in the second digital image as the line of pixels 421 in the first digital image 410. In another embodiment, the corresponding line of pixels 451 may be selected based on some other criteria. For example, the corresponding line of pixels 451 may be related to the line of pixels 421 based on a location of the line of pixels 421 and a motion vector associated with the second digital image 440. The motion vector may be determined by comparing a low resolution version (i.e., thumbnail) of the first digital image 410 with a low resolution version of the second digital image 440 to determine an approximate translation of the digital images caused by, e.g., camera motion.

Once the corresponding line of pixels 451 is selected, the gradients for the pixels in the corresponding line of pixels 451 are calculated and one or more additional features in the corresponding line of pixels 451 are identified. The one or more additional features are identified by comparing the gradients in the same manner as the feature pixels in the first digital image 410 were identified. Once the one or more additional features are identified, a processor matches the feature pixel 422 in the first digital image 410 with one of the additional feature pixels in the second digital image 440. In one embodiment, the feature pixel 422 corresponds to a maximum gradient in the line of pixels 421. Consequently, the feature pixel 422 is matched to any feature pixel in the corresponding line of pixels 451 that is associated with the maximum gradient in the corresponding line of pixels 451. In another embodiment, the feature pixel 422 is matched to the feature pixel in the corresponding line of pixels 451 that most closely resembles the feature pixel 422. For example, the processor may compare the values of the gradients associated with each additional feature pixel in the second digital image 440 with the gradients associated with the feature pixel 422 in order to find a matching pixel in the second digital image 440. The processor may also compare the intensity of the pixels associated with the feature, or in the direct vicinity of the feature, to determine which pixel in the corresponding line of pixels 451 matches the feature pixel 422. The pair of matching pixels is added to a set of matching pixels for the pair of images. More than one feature pixel in the line of pixels 421 in the first digital image 410 may be matched to more than one corresponding pixel in the corresponding line of pixels 451 and added to the set of matching pixels. Similarly, the set of matching pixels may include corresponding pairs of matching pixels from multiple lines of pixels in the first digital image 410 and multiple corresponding lines of pixels in the second digital image 440.

Once the set of matching pixels has been identified, the second digital image 440 may be registered to the first digital image 410 based on the set of matching pixels. For example, a transformation may be defined based on the locations of the pairs of matching pixels in the set of matching pixels. In one embodiment, at least four pairs of matching pixels may be used to define a homography matrix that represents a transformation of the first digital image 410 into the second digital image 440, or vice versa.

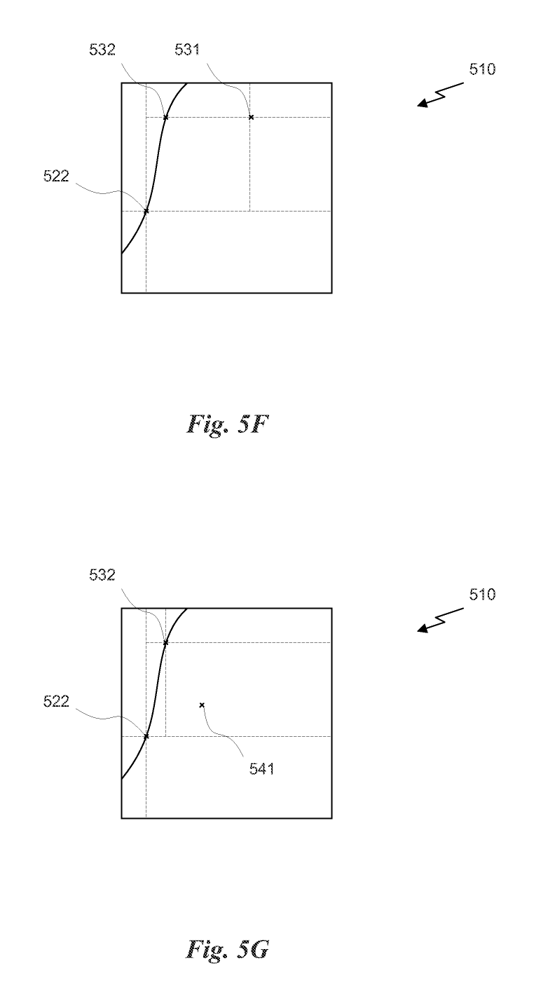

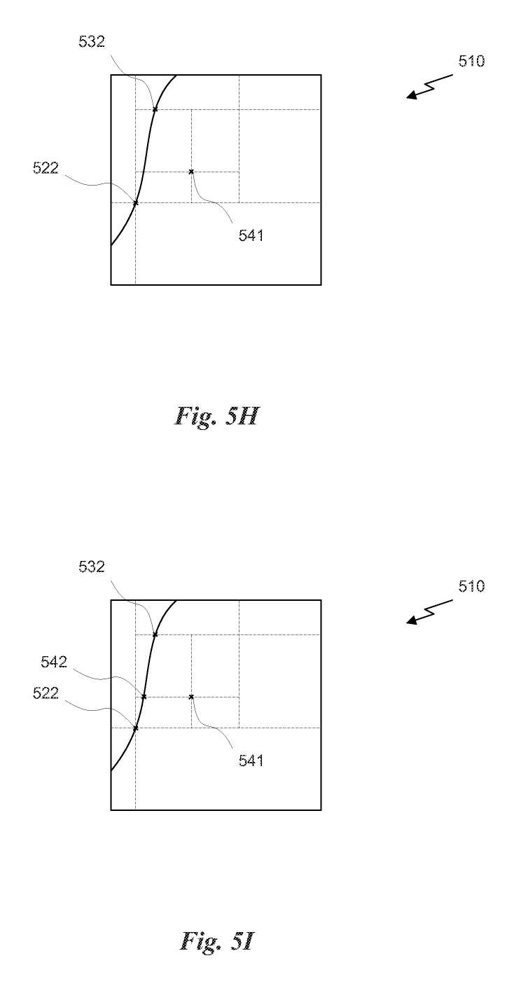

FIGS. 5A through 5I illustrate a technique for detecting features in a digital image 500, in accordance with another embodiment. An algorithm for detecting features may be implemented by the device 200. In one embodiment, the device 200 implements the algorithm by executing a plurality of instructions via the CPU 212 and/or the GPU 214. In another embodiment, the device 200 implements the algorithm in hardware or some combination of hardware and software. For example, the IPP 250 may include a stage that implements the algorithm. The stage may be implemented in a digital circuit or may be implemented by some combination of a digital circuit and/or a programmable unit executing software instructions.

As shown in FIG. 5A, the digital image 500 comprises an N×M array of pixels. In one embodiment, the algorithm may be implemented by dividing the digital image 500 into a plurality of blocks 510. For example, the digital image 500 may be divided into macroblocks that are 64 pixels by 64 pixels in size. The blocks 510 may be rectangular or square and each comprise a portion (i.e., a subset of pixels) of the digital image 500. Once the digital image 500 has been divided into the plurality of blocks 510, one or more sample points 521 are selected for each block 510. Each sample point 521 may be randomly generated or the sample point 521 may be selected from a table, e.g., based on the location of a particular block 510 within the digital image 500. It will be appreciated that the sample points 521 are jittered and are not evenly distributed throughout the digital image 500.

As shown in FIG. 5B, for each block 510, a search is performed based on the location of the corresponding sample point 521 for the block 510. The set of paths for the feature search within a block 510 may include a horizontal line of pixels that intersects the sample point 521 and a vertical line of pixels that intersects the sample point 521. A gradient in the x-direction is calculated for each pixel included in the horizontal line of pixels. In addition, a gradient in the y-direction is calculated for each pixel included in the vertical line of pixels. In some embodiments, the set of paths within a block may include a different set of pixels than shown in FIG. 5B, such as choosing only a single horizontal or vertical line, a single diagonal line, or multiple combinations of the aforementioned lines as the set of paths. As shown in FIG. 5C, a pixel associated with the maximum gradient value in both the horizontal line of pixels and the vertical line of pixels is selected as a feature pixel 522.

Selecting a single feature pixel 522 from only a subset of pixels in the block 510 (e.g., one or more lines of pixels that intercept the sample pixel 521) significantly reduces the computational load for identifying the feature pixel 522 when compared to calculating gradients for each pixel in the block 510. Furthermore, each block 510 may be processed independently in parallel to further reduce computation time of the algorithm. However, there is a chance that the randomly selected sample point 521 will be chosen such that the search of the set of paths does not intersect with any features in the block 510 or that the feature pixel 522 does not represent one of the more prominent features within the block 510. In order to improve the accuracy of the algorithm, an iterative process may be performed to find additional feature pixels 522 in the block of pixels 510. As shown in FIG. 5D, the feature pixel 522 divides the block of pixels 510 into four quadrants. It will be appreciated that, unless the feature pixel 522 is located at the exact center of the block 510, one of the quadrants will be larger than the other three quadrants. It will be appreciated that if the block 510 has an even number of pixels in both dimensions, then one quadrant will always be larger than the other quadrants. As used herein, a quadrant refers to one of four portions of a block 510 having boundaries defined by the x-coordinate and y-coordinate of the feature pixel 522. The quadrant having the maximum area is selected and another sample point 531 is selected inside the quadrant. Again, the sample point 531 may be selected randomly or based on a pre-defined table.

As shown in FIG. 5E, the technique described above for finding a feature pixel 522 associated with the sample point 521 is then repeated for the quadrant to select another feature pixel. A second set of paths including a horizontal line of pixels within the quadrant that intersects the sample point 531 and a vertical line of pixels within the quadrant that intersects the sample point 531 are searched to identify another feature pixel. It will be appreciated that the search is limited to the pixels included in the set of paths within the quadrant and, therefore, the number of pixels that have a gradient calculated during the search is reduced when compared to the first iteration performed above. As shown in FIG. 5F, a pixel associated with the maximum gradient value in the set of paths is selected as a feature pixel 532. After two iterations, two feature pixels have been selected for the block 510, a feature pixel 522 and a feature pixel 532.

Further iterations may be performed to increase the number of feature pixels selected for each block 510. For example, as shown in FIG. 5G, a third iteration may be performed. A third sample pixel 541 is selected in the largest quadrant of the previous portion of the block 510. The quadrant is defined by the location of the feature pixel 532 and bounded by the boundaries of the quadrant selected during the previous iteration. Again, the sample pixel 541 may be selected randomly or may be selected from a table based on the location of the block 510 and/or an index that represents the number of iterations that have been performed. In some embodiments, any hash function may be used to select a location of the sample pixel 541 from a table.

As shown in FIG. 5H, a search is performed to find another feature pixel based on the location of the sample point 541. Another set of paths including a horizontal line of pixels within the new quadrant that intersects the sample point 541 and a vertical line of pixels within the new quadrant that intersects the sample point 541 are searched to identify another feature pixel. As shown in FIG. 5I, a pixel associated with the maximum gradient value is selected as a feature pixel 542. After three iterations, three feature pixels have been selected, feature pixel 522, feature pixel 532, and feature pixel 542.

In one embodiment, a user or application may call a function that automatically detects features in a digital image 500 by implementing the techniques illustrated above in FIGS. 5A through 5I. The function may include input arguments that specify the filename, a size or number of blocks to divide the digital image 500 into, and a number of iterations to perform in order to select one or more feature pixels per block of pixels 510 in the digital image 500.

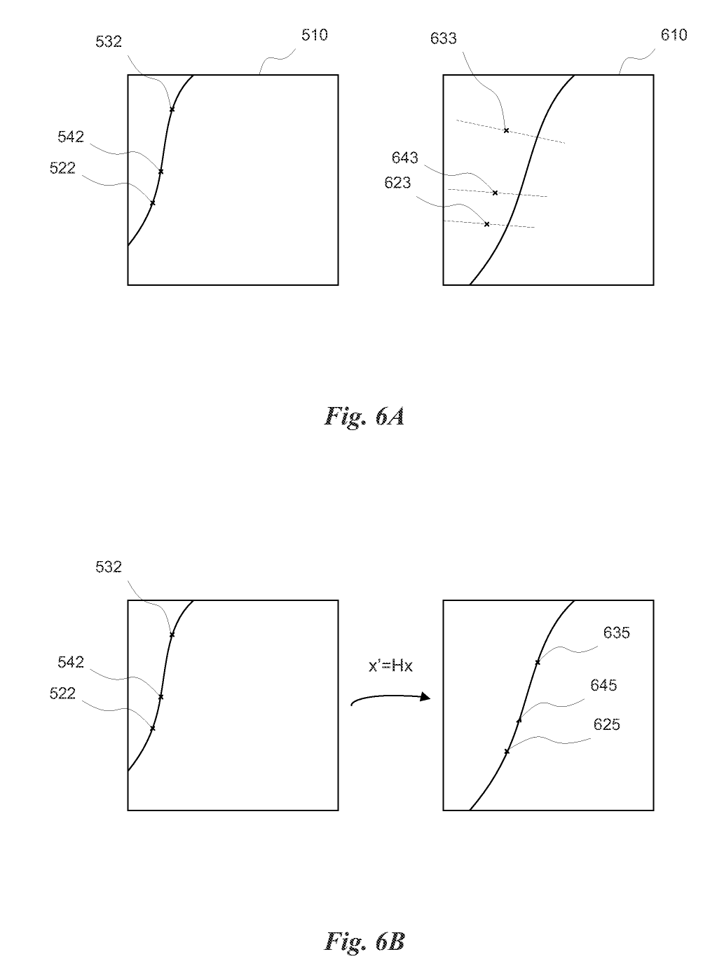

FIGS. 6A & 6B illustrate one application of the feature detection techniques described above, in accordance with one embodiment. The algorithm may be utilized for generating high dynamic range (HDR) images, or registering image stacks for other purposes, such as image denoising. An HDR image stack is a set of images that show approximately the same scene taken at different exposure settings (e.g., exposure time, aperture setting, etc.). These images may capture details at both low exposure settings and high exposure settings in different images that could not be captured with a single image sensor at a particular exposure setting. Such details would either be overexposed (i.e., oversaturated) or underexposed (i.e., undersaturated). The HDR image stack therefore captures these details at different exposure settings over a short period of time and then blends the images to create an HDR image that has more detail than would be captured using a single exposure.

One issue with the blending of HDR image stacks is that the objects in the scene tend to move from one image to the next. Even though the set of images may be captured over approximately half a second, the objects may move a noticeable amount that could create ghosting artifacts if the images were simply blended together. One solution to this issue is to select a reference image and then warp pixels in the other images in the image stack such that pixels associated with a particular object in the warped image are moved to a corresponding pixel location in the reference image. Algorithms for performing this warping function may utilize the feature search algorithms set forth above in order to more efficiently compute a homography matrix, H, for performing the warp function.

For example, as shown in FIG. 6A, a feature in a block of pixels 510 in a reference image may be matched to a feature in a corresponding block of pixels 610 in a second image. The feature search algorithm may be utilized to find one or more feature pixels (e.g., 523, 533, and 543) in the block 510 in the reference image. Once the feature pixels have been selected, a feature search of a corresponding line of pixels in the corresponding block of pixels 610 in the second image is performed for each feature pixel in the block 510 of the reference image.

For each feature pixel in the block 510, a corresponding pixel in the block 610 is determined. For example, a feature pixel 522 is matched with a corresponding pixel 623, a feature pixel 532 is matched with a corresponding pixel 633, and a feature pixel 542 is matched with a corresponding pixel 643. In one embodiment, the corresponding pixel may be located at the same pixel location in the block 610 as the pixel location of the feature pixel in the block 510. In another embodiment, the corresponding pixel may be determined by transforming the pixel location for the feature pixel based on a coarse registration. For example, a coarse registration of the reference image to the second image may be performed on lower resolution versions (i.e., thumbnails) of the image. The coarse registration may determine a motion vector that approximates the transformation of the scene between the two images. Because the coarse registration represents a transformation of the entire image, the coarse registration is not accurate at representing local transformations of every object. Therefore, applying the coarse registration to transform the pixel location of the feature pixels in the block 510 of the reference image into a new pixel location in the block 610 in the second image is likely to merely approximate the location of a matching feature pixel in the corresponding block of pixels 610. Thus, another set of searches are performed for pixels adjacent to the selected corresponding pixels in the block 610 to attempt to locate the matching pixels for each of the feature pixels. There are many ways to calculate a coarse registration transformation, for example, it may be sufficient to estimate a 2D translation between the images before refining the estimate using the techniques disclosed herein.

As shown in FIG. 6A, a feature pixel 522 is associated with a corresponding pixel 623 in the block of pixels 610 in the second image. A one-dimensional search is performed for a plurality of pixels adjacent to the corresponding pixel 623. In one embodiment, a line of pixels may be selected, where the line has a slope approximately equal to a normal of the feature pixel 522, which may be calculated based on the intensity values of the gradients for the feature pixel 522 in both the x-direction and the y-direction. The number of pixels in the line of pixels may be limited and does not necessarily span the entire block 610. For example, the line of pixels may include 25 pixels, which would not span a block of pixels 64 pixels wide by 64 pixels high. In one embodiment, the search calculates a gradient (or multiple gradients) for each pixel in the line of pixels and selects a pixel having a gradient(s) that most closely matches the gradient(s) of the feature pixel 522. In addition to matching the gradient, the search algorithm may attempt to also match the intensity values on both sides of the potentially matching feature. For example, the algorithm may attempt to confirm that the lower intensity value on one side of the potential matching pixel is on the same side of the feature pixel 522. These checks may be able to distinguish a matching pixel with more accuracy when multiple potential matches are discovered on the line of pixels. Similarly, a feature pixel 532 is associated with a corresponding pixel 633 in the block 610, and a feature pixel 542 is associated with a corresponding pixel 643 in the block 610. The search is performed for lines of pixels adjacent to pixels 633 and 643 as well.

As shown in FIG. 6B, the searches identify corresponding matching pixels 625, 635, and 645 in the block 610 of the second image. These matching pixels are a best estimate of pixels that represent the transformation of objects from the reference image to the second image. The set of feature pixels in the reference image (i.e., all feature pixels from block 510 as well as other blocks in the reference image) and the set of matching feature pixels in the second image (i.e., all feature pixels from block 610 as well as other blocks in the reference image) may be used to compute a homography matrix H that represents the transformation of the reference image to the second image, or vice versa.

It will be appreciated that the algorithm described above with reference to FIGS. 6A and 6B is only one possible algorithm that could utilize the feature search algorithm. Other types of algorithms may also utilize the feature search algorithm. For example, the feature search algorithm may be utilized in facial recognition software. The scope of the present disclosure is not limited to specific algorithms described herein, hut is applicable to any type of algorithm that utilizes feature search algorithms in 2D images.

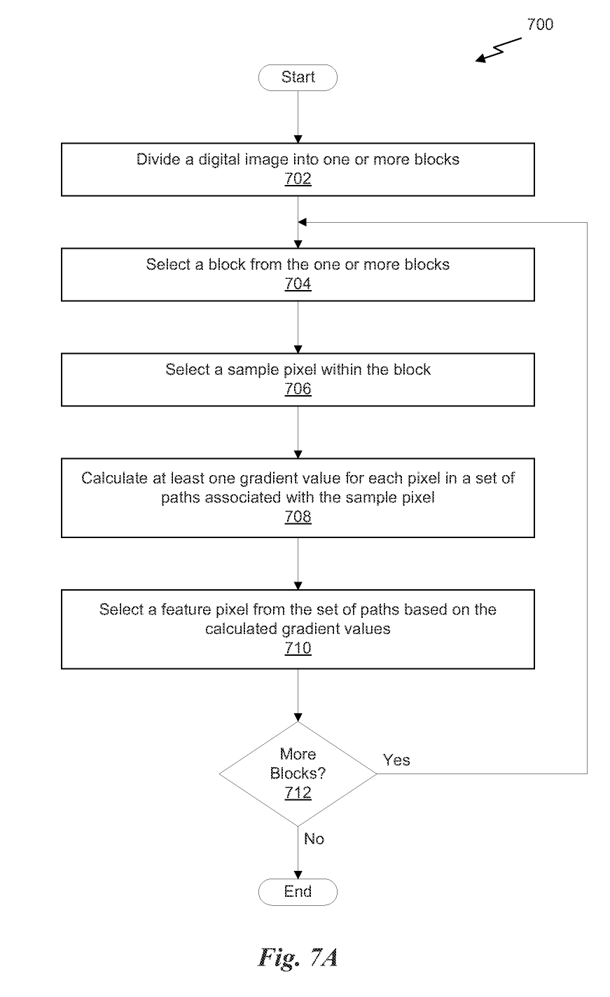

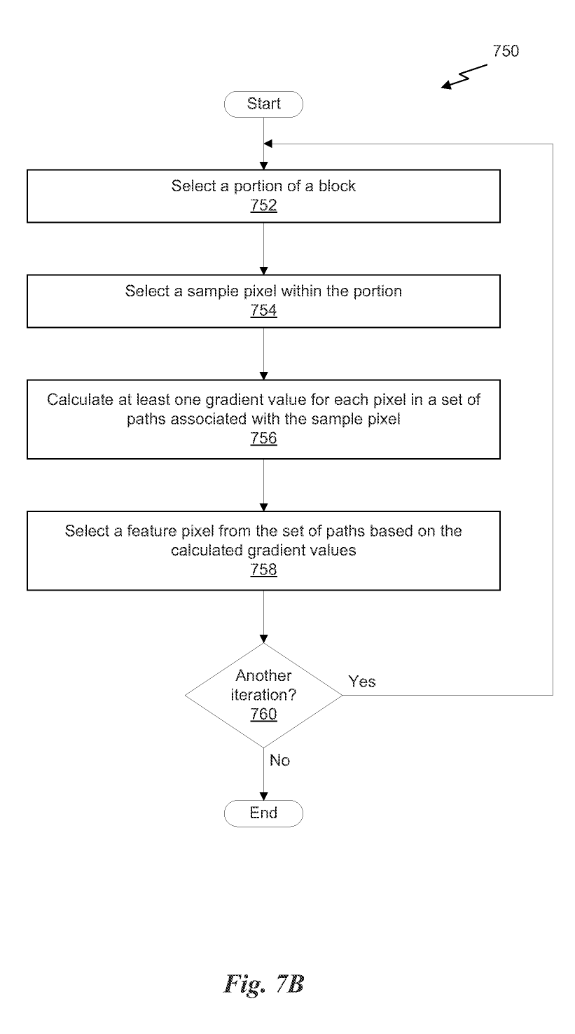

FIG. 7A illustrates a flow chart of a method 700 for performing a search of a digital image, in accordance with another embodiment. At step 702, a digital image is divided into one or more blocks. In the context of the following description, a block comprises a plurality of adjacent pixels. A block of pixels may be, e.g., a two-dimensional array of pixels such as a 64 pixel by 64 pixel portion of the digital image. In one embodiment, the digital image is divided into a plurality of blocks and each block may be processed independently. At step 704, a block is selected from the one or more blocks.

At step 706, a sample pixel is selected within the block. In the context of the following description, a sample pixel represents a location associated with a feature search algorithm performed on a plurality of pixels within the block. At step 708, at least one gradient value is calculated for each pixel in a set of paths associated with the sample pixel. A gradient value may represent a difference in an intensity level of one pixel compared to at least one adjacent pixel. In one embodiment, the set of paths includes at least one line of pixels that intersects the sample pixel. The line of pixels may be horizontal, vertical, diagonal, or some orientation with respect thereto. In another embodiment, the set of paths comprises both a horizontal line of pixels that intersects the sample pixel and a vertical line of pixels that intersects the sample pixel. At step 710, a feature pixel is selected from the set of paths based on the gradient values for the pixels in the set of paths. In the context of the following description, a feature pixel is any pixel selected from a group of pixels that is associated with a gradient value having a certain characteristic. In one embodiment, the feature pixel represents the pixel in the set of paths associated with the largest gradient value.

At step 712, a processor determines whether another block should be processed. If there are more blocks to process, then the method 700 returns to step 704, where another block is selected and steps 706 through 710 are executed to find another feature pixel for a different block. However, if at step 712 there are no additional blocks to process, then the method 700 terminates.

FIG. 7B illustrates a flow chart of a method 750 for performing a search of a digital image, in accordance with yet another embodiment. In one embodiment, the feature search algorithm is configured to perform multiple iterations per block of pixels in order to find multiple feature pixels per block. In such an embodiment, the method 700 may be modified to replace steps 706 through 710 with the steps of method 750. At step 752, a portion of a block is selected. During a first iteration, the portion may comprise the entire block of pixels. At step 754, a sample pixel is selected within the portion. In one embodiment, the sample pixel may be selected randomly using a random number generator to identify the x and y coordinates for the sample pixel. At step 756, at least one gradient value is calculated for each pixel in a set of paths associated with the sample pixel. At step 758, a feature pixel is selected from the net of paths based on the gradient values for the pixels in the set of paths.

At step 760, a processor determines whether another iteration should be performed for the block of pixels. In the context of the following description, an iteration comprises a series of steps that may be repeated one or more times. For example, each iteration may comprise performing the steps 754 through 758 for a different portion of the block of pixels to select multiple feature pixels in the block of pixels. If another iteration should be performed, then the method 750 returns to step 752 where a new portion is selected. In one embodiment, the new portion may correspond to a quadrant of the previous portion having a maximum area, wherein the quadrants are defined based on the location of the feature pixel selected during the previous iteration. Steps 754 through 758 are then performed based on the new portion. Returning to step 760, if no additional iterations should be performed, then the method 750 terminates.

It will be appreciated that the methods 700 and 750 may be implemented by the device 200 or any other type of device including a processor configured to implement the steps of the algorithm.

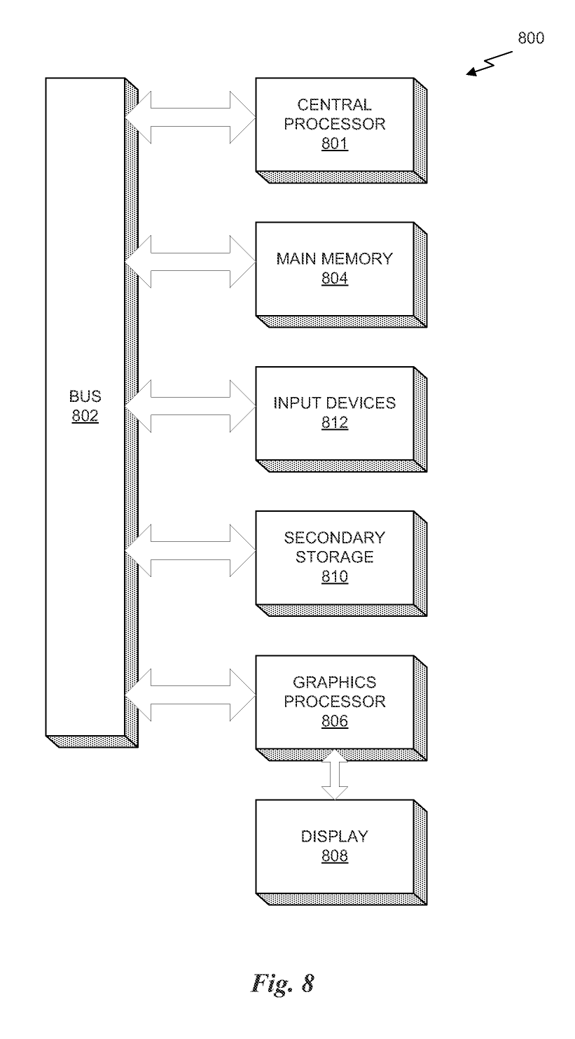

FIG. 8 illustrates an exemplary system 800 in which the various architecture and/or functionality of the various previous embodiments may be implemented. As shown, a system 800 is provided including at least one central processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a main memory 804. Control logic (software) and data are stored in the main memory 804 which may take the form of random access memory (RAM).

The system 800 also includes input devices 812, a graphics processor 806, and a display 808, i.e. a conventional CRT (cathode ray tube), LCD (liquid crystal display), LED (light emitting diode), plasma display or the like. User input may be received from the input devices 812, e.g., keyboard, mouse, touchpad, microphone, and the like. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also he situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage 810. Such computer programs, when executed, enable the system 800 to perform various functions. The memory 804, the storage 810, and/or any other storage are possible examples of computer-readable media.

In one embodiment, the architecture and/or functionality of the various previous figures may be implemented in the context of the central processor 801, the graphics processor 806, an integrated circuit (not shown) that is capable of at least a portion of the capabilities of both the central processor 801 and the graphics processor 806, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit hoard system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above--described exemplary embodiments, but should be defined only in accordance with the following claims and their equivalents.

What is claimed is:

1. A method comprising:
selecting a set of paths in an image, wherein the set of paths includes at least one line of pixels in the image, and wherein a total number of pixels in the set of paths is less than half of a number of pixels in the image; and
identifying at least one feature pixel in the set of paths by comparing gradients for each of the pixels in the set of paths.

2. The method of claim 1, wherein identifying at least one feature pixel in the set of paths comprises, for each line of pixels in the set of paths, selecting one or more pixels in the line of pixels associated with gradient data that identifies a feature.

3. The method of claim 1, further comprising dividing the image into a plurality of blocks, wherein each block in the plurality of blocks includes at least one line of pixels in the set of paths.

4. The method of claim 3, wherein identifying at least one feature pixel in the set of paths comprises processing at least two blocks in parallel by calculating gradients for each of the pixels in the at least one line of pixels in each block and identifying at least one feature pixel per block based on the gradient data.

5. The method of claim 3, wherein, for each block in the plurality of blocks, the at least one line of pixels in the set of paths includes a first horizontal line of pixels and a first vertical line of pixels in the block.

6. The method of claim 5, wherein the horizontal line of pixels and the vertical line of pixels are selected based on a random sample point in the block.

7. The method of claim 5, wherein identifying at least one feature pixel in the set of paths comprises, for each block in the plurality of blocks, selecting a pixel in the horizontal line of pixels and the vertical line of pixels based on gradient data associated with each pixel in the horizontal line of pixels and the vertical line of pixels and identifying the selected pixel as a first feature pixel for the block.

8. The method of claim 7, further comprising, for each block:
selecting a portion of the block based on a location of the feature pixel for the block;
selecting a second horizontal line of pixels and a second vertical line of pixels in the portion of the block, wherein the second horizontal line of pixels and the second vertical line of pixels are included in the set of paths; and
identifying a second feature pixel for the block based on gradient data associated with each pixel in the second horizontal line of pixels and the second vertical line of pixels.

9. The method of claim 1, further comprising:
selecting a corresponding set of paths in a second image; and
identifying at least one matching pixel in the second image corresponding to the at least one feature pixel in the image.

10. The method of claim 9, wherein a location of the set of paths in the first image matches a location of the corresponding set of paths in the second image.

11. The method of claim 9, wherein a location of the corresponding set of paths in the second image is based on a coarse translation of a location of the set of paths in the first image.

12. The method of claim 9, wherein the corresponding set of paths in the second image is selected based on a location and at least one gradient value for each feature pixel in the at least one feature pixel.

13. The method of claim 1, further comprising, for each feature pixel in the at least one feature pixel in the image, locating a matching pixel in a second image based on a sparse optical flow.

14. A non-transitory computer-readable storage medium storing instructions that, when executed by a processor, cause the processor to perform steps comprising:
selecting a set of paths in an image, wherein the set of paths includes at least one line of pixels in the image, and wherein a total number of pixels in the set of paths is less than half of a number of pixels in the image; and
identifying at least one feature pixel in the set of paths by comparing gradients for each of the pixels in the set of paths.

15. The non-transitory computer-readable storage medium of claim 14, the steps further comprising dividing the image into a plurality of blocks, wherein each block in the plurality of blocks includes at least one line of pixels in the set of paths.

16. The non-transitory computer-readable storage medium of claim 15, wherein identifying at least one feature pixel in the set of paths comprises processing at least two blocks in parallel by calculating gradients for each of the pixels in the at least one line of pixels in each block and identifying at least one feature pixel per block based on the gradient data.

17. The non-transitory computer-readable storage medium of claim 14, the steps further comprising:
selecting a corresponding set of paths in a second image; and
identifying at least one matching pixel in the second image corresponding to the at least one feature pixel in the image.

18. A system, comprising:
a memory that stores an image; and a processor coupled to the memory and configured to:
select a set of paths in an image, wherein the set of paths includes at least one line of pixels in the image, and wherein a total number of pixels in the set of paths is less than half of a number of pixels in the image; and
identify at least one feature pixel in the set of paths by comparing gradients for each of the pixels in the set of paths.

19. The system of claim 17, the processor further configured to divide the image into a plurality of blocks, wherein each block in the plurality of blocks includes at least one line of pixels in the set of paths.

20. The system of claim 17, wherein the memory stores a second image, the processor further configured to:
select a corresponding set of paths in the second image; and
identify at least one matching pixel in the second image corresponding to the at least one feature pixel in the image.
